(19) United States
(12) Patent Application Publication
(10) Pub. No.: US 2015/0365599 A1
(43) Pub. Date: Dec. 17, 2015

(54) INFORMATION PROCESSING APPARATUS, IMAGE CAPTURING APPARATUS, AND CONTROL METHOD

(71) Applicant: CANON KABUSHIKI KAISHA, Tokyo (JP)

(72) Inventor: Masafumi Kimura, Kawasaki-shi (JP)

(21) Appl. No.: 14/735,471

(22) Filed: Jun. 10, 2015

(30) Foreign Application Priority Data
Jun. 12, 2014 (JP) 2014-121846

(51) Int. Cl. H04N 5/232

(52) U.S. Cl. CPC H04N 5/23293; H04N 5/23229

(57) ABSTRACT

An information processing apparatus obtains information of a plurality of viewpoints corresponding to images in which a same subject is captured. Then the apparatus detects a region of interest within a captured range including the subject, and displays, on a display medium, an image corresponding to a display viewpoint selected as a viewpoint corresponding to the region of interest from among the plurality of viewpoints.

### BACKGROUND OF THE INVENTION

1. Field of the Invention

The present invention relates to an information processing apparatus, an image capturing apparatus, and a control method, and particularly to a technology for playing back data including images related to a plurality of viewpoints.

2. Description of the Related Art

Among image capturing apparatuses such as digital cameras, some apparatuses record information of the intensity distribution and traveling direction of light (light field information) during image capturing. Japanese Patent Laid-open No. 2007-4471, Ren Ng, et al., 2005, “Light Field Photography with a Hand-held Plenoptic Camera”, Computer Science Technical Report CTSR, and Todor Georgiev, et al., “Superresolution with Plenoptic 2.0 Cameras”, 2009, Optical Society of America, disclose a technique using a microlens array to record the light field information. According to this technique, each of the light beams that pass through different divided pupil regions of an image capturing lens forms an image on one of the pixels (photoelectric converters) of an image sensor, and thus incident light from various directions is divided into portions. The light field information obtained in this way has a plurality of images corresponding one-to-one to the plurality of divided pupil regions, in other words, a plurality of images related to different viewpoints.

The three-dimensional shape of an object within a space is visually recognized by perceiving a difference (binocular disparity) between optical images formed on the respective retinas of the eyeballs. The difference is caused by the fact that the left eyeball and the right eyeball are located with a given eye separation therebetween. In addition, even when an object is observed with only one of the eyeballs, the three-dimensional shape can be recognized from a difference (motion parallax) between optical images that occur successively in terms of time, along with movement of the position of the head.

An image captured by a single-eye image capturing apparatus is, like an optical image observed with one of the eyeballs, a two-dimensional projection of a subject's image, and the three-dimensional shape of the subject cannot be recognized from the image. In recent years, there has also been an image capturing apparatus that takes advantage of the principle of motion parallax described above, and this image capturing apparatus, when displaying an image on a display device of the image capturing apparatus, switches between images capturing a same subject and related to different viewpoints, according to the tilt angle of the image capturing apparatus, thereby allowing the observer to perceive the three-dimensional shape of the subject.

However, the method of switching between the images according to changes in tilt angle of the image capturing apparatus and thereby enabling the observer to perceive the three-dimensional shape is available only when the image capturing apparatus is used for the purpose of playing back images that have been recorded. In other words, when the photographer is looking through the electronic viewfinder to determine the composition of the picture (aiming or framing) for example, it is not desirable to tilt the image capturing apparatus, and therefore the presentation of the three-dimensional shape by the above-described method is not feasible.

### SUMMARY OF THE INVENTION

The present invention was made in view of such problems in the conventional technique. The present invention provides an information processing apparatus, an image capturing apparatus, and a control method that are capable of, when displaying images related to a plurality of viewpoints, selecting a display viewpoint from which the observer can perceive the three-dimensional shape of the subject in a preferable manner.

The present invention in its first aspect provides an information processing apparatus comprising: an obtaining unit configured to obtain information of a plurality of viewpoints corresponding to images in which a same subject is captured; a detection unit configured to detect a region of interest within a captured range including the subject; a selection unit configured to select, as a display viewpoint, a viewpoint corresponding to the region of interest detected by the detection unit from among the plurality of viewpoints obtained by the obtaining unit; and a display unit configured to display, on a display medium, an image corresponding to the display viewpoint selected by the selection unit, among the images in which the same subject is captured.

The present invention in its second aspect provides an image capturing apparatus comprising: an image capturing unit configured to obtain images that are related to a plurality of viewpoints and in which a same subject is captured; a detection unit configured to detect a region of interest within a captured range including the subject; a selection unit configured to select, as a display viewpoint, a viewpoint corresponding to the region of interest detected by the detection unit from among the plurality of viewpoints; and a display unit configured to display, on a display medium, an image corresponding to the display viewpoint selected by the selection unit, among the images related to the plurality of viewpoints.

The present invention in its third aspect provides an information processing apparatus control method comprising: an obtaining step of obtaining information of a plurality of viewpoints corresponding to images in which a same subject is captured; a detection step of detecting a region of interest within a captured range including the subject; a selection step of selecting, as a display viewpoint, a viewpoint corresponding to the region of interest detected in the detection step from among the plurality of viewpoints obtained in the obtaining step; and a display step of displaying, on a display medium, an image corresponding to the display viewpoint selected in the selection step, among the images in which the same subject is captured.

Further features of the present invention will become apparent from the following description of exemplary embodiments (with reference to the attached drawings).

### BRIEF DESCRIPTION OF THE DRAWINGS

FIGS. 1A and 1B are diagrams showing a configuration of a camera system according to an embodiment of the present invention.

FIGS. 2A, 2B, and 2C are diagrams showing a configuration of an image capturing unit 102 according to an embodiment of the present invention.

FIGS. 3A, 3B, 3C, and 3D are diagrams illustrating an optical architecture capable of obtaining images related to a plurality of viewpoints.

FIG. 4 is a flowchart showing an example of display control processing performed by a camera system according to an embodiment of the present invention.

FIGS. 5A and 5B are diagrams illustrating a display mode of a finder display unit 107 according to an embodiment of the present invention.

FIGS. 6A, 6B, and 6C are diagrams illustrating a display mode of a finder display unit 107 according to an embodiment and Modification 1 of the present invention.

FIGS. 7A and 7B are diagrams showing a configuration to which the present invention is applicable.

### DESCRIPTION OF THE EMBODIMENTS

### Embodiment

The following provides a detailed description of an exemplary embodiment of the present invention, with reference to the drawings. Note that the following embodiment describes an example case where the present invention is applied to a camera system that is an example of an information processing apparatus and that is capable of, by capturing an image of a same subject, obtaining images related to a plurality of viewpoints each corresponding to a different position. However, the present invention is applicable to any devices which are capable of selecting a display viewpoint from among a plurality of viewpoints that are related to images in which a same subject is captured and that each corresponds to a different position.

Configuration of Camera System

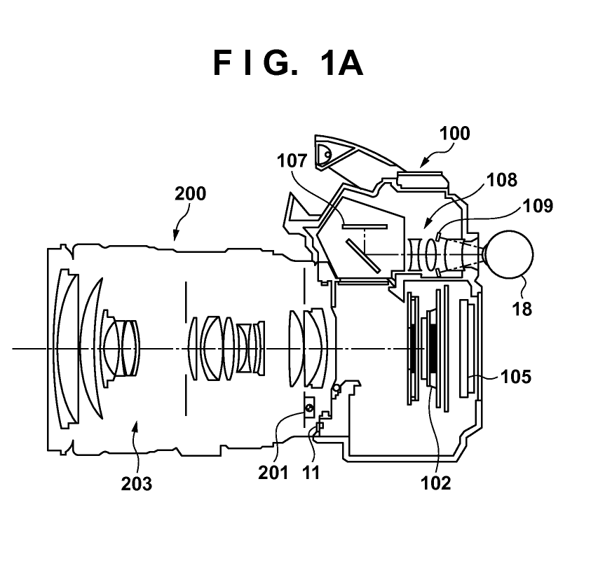

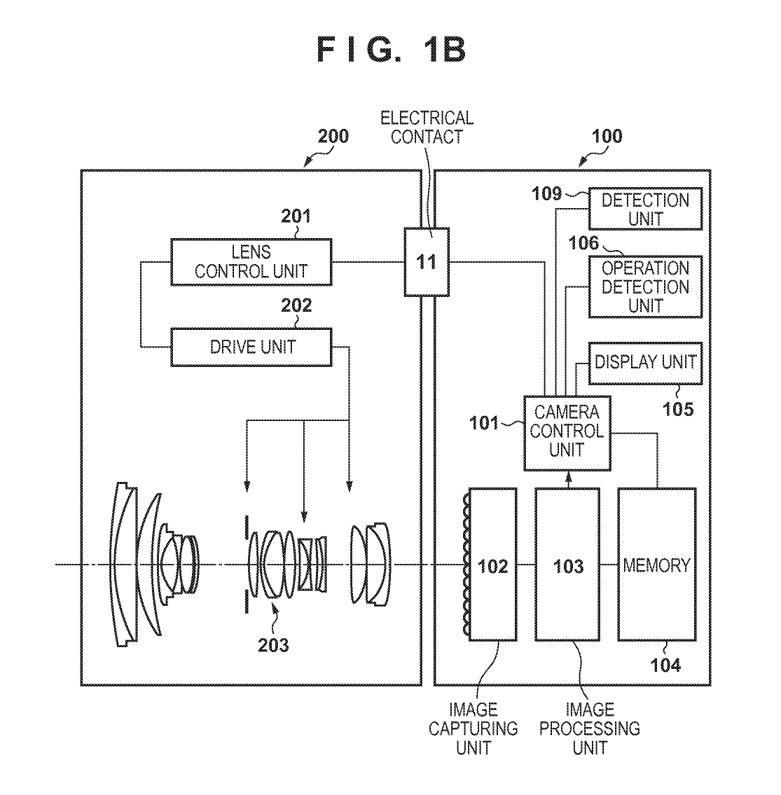

FIGS. 1A and 1B show a configuration of a camera system according to an embodiment of the present invention, which includes a camera body 100 and a lens barrel 200. FIG. 1A is a cross-sectional view of the camera system along a cross section passing through the optical axis of an image capturing optical system 203 included in the lens barrel 200, and shows the arrangement of the constituent elements. FIG. 1B is a block diagram showing the functional configuration of the camera body 100 and the lens barrel 200. As shown in FIG. 1B, the camera body 100 and the lens barrel 200 are electrically connected at an electrical contact 11, and a camera control unit 101 and a lens control unit 201 are configured to be capable of communicating with each other.

The camera control unit 101 is a control device such as a CPU or a microprocessor, and controls each of the blocks included in the camera body 100. The camera control unit 101 is configured to have a non-volatile memory, which is not shown in the drawing, and to control the operation of each block by reading out an operation program for each block, which is stored in the non-volatile memory, loading the program into a loading region such as a memory 104, and executing the program. The camera control unit 101 transmits signals for controlling the operation of each block of the lens barrel 200 to the lens control unit 201 via the electrical contact 11.

The image capturing unit 102 has an image sensor such as CCD or CMOS sensor, which includes photoelectric converters that are two-dimensionally arranged on a plane that is orthogonal to the optical axis. The image capturing unit 102 performs photoelectric conversion of an optical image formed by the image capturing optical system 203 on the image forming surface of the image sensor, and outputs, to an image processing unit 103, a captured-image signal (an analogue image signals) related to the subjects within the captured range.

Configuration of Image Capturing Unit 102

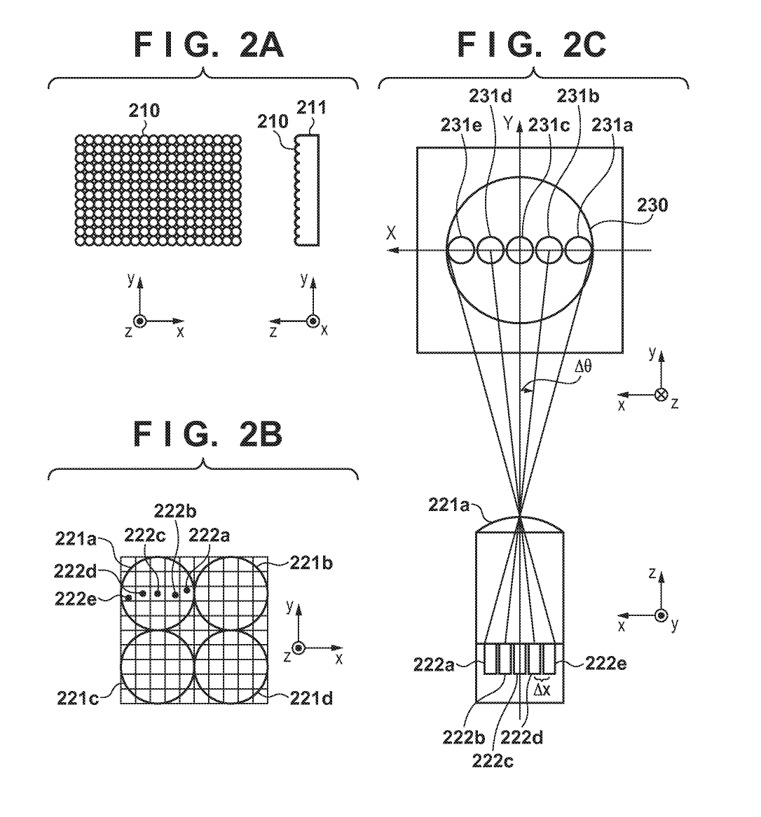

The following describes a configuration of the image capturing unit 102 according to the present embodiment with reference to FIGS. 2A to 2C.

In order to simultaneously obtain images related to a plurality of viewpoints, the camera body 100 of the present embodiment is, as shown in FIG. 2A, provided with a microlens array (MLA) 210 including a plurality of microlenses that are two-dimensionally arranged on the surface of the image capturing unit 102, the surface located near the image forming surface and orthogonal to the optical axis of the image capturing optical system 203. In FIG. 2A, the x axis and the y axis are respectively defined in the horizontal direction and the vertical direction of the image forming surface of the image sensor 211, and the z axis is defined in the optical axis direction so that a right-handed system is formed. The MLA 210 seen in the negative direction of the z axis and the same seen in the negative direction of the x axis are depicted in this drawing.

Each microlens 221 of the MLA 210 is, as shown in FIG. 2B, assigned to a group of a predetermined number of photoelectric converters of the image sensor 211 (25 photoelectric converters in the drawing), and spreads the incident light beam over the coverage of the photoelectric converters thus assigned, so as to form an image. Thus, the incident light beam to the microlens 221 is recorded after being divided by the plurality of photoelectric converters. For example, in FIG. 2B, when the attention is focused on the microlens 221a as well as the photoelectric converters 222a to 222e arranged in the horizontal direction from among the photoelectric converters assigned to the microlens, the light beams received by the photoelectric converters and the incident light beams to the image capturing optical system 203 are in the relationship shown in FIG. 2C. As shown in FIG. 2C, the light beams entering the microlens 221a after passing through an exit pupil 230 of the image capturing optical system 203 are spread over the photoelectric converters 222a to 222e that are in a conjugative relationship, and each form an image. Accordingly, each photoelectric converter receives a light beam from a different one of pupil regions 231 of the exit pupil 230. Note that in FIG. 2C the signs a to e added to the pupil regions 231 correspond to the signs added to the photoelectric converters 222, and specify, for each of the pupil regions on the exit pupil surface, which photoelectric converter receives the light beam passing through the pupil region. In FIG. 2C, when Δx denotes the interval (pixel pitch) between the photoelectric converters of the image sensor 211, the angular resolution A is determined by using the number N_{θ} of the divisions of the angle (N_{θ}=5 in FIG. 2C). In other words, parameters such as the coverage of each photoelectric converter and the direction of the light ray can be specified solely by the physical configurations (the configurations of the image sensor 211 and the MLA 210).

By providing the MLA 210, the photoelectric converters assigned to any of the microlenses are each capable of recording a light beam passing through a different one of the pupil regions, and therefore images related to different viewpoints, the number of which is the same as the number of pupil divisions, can be obtained by classifying the obtained captured-image signals according to the pupil regions passed through. In the present embodiment, data corresponding to the captured-image signals (light field information) obtained by providing the MLA 210 on the optical axis is described as data including images related to a plurality of viewpoints. However, the method for obtaining the data is not limited in this way. In other words, images related to a plurality of viewpoints are not necessarily images obtained by recording the light beams resulting from the pupil division as performed in the present embodiment, and may be obtained by simultaneously or intermittently performing image capturing by using an image capturing apparatus having a plurality of optical systems such as a multi-eye camera or a plurality of image capturing apparatuses. Alternatively, images related to a plurality of viewpoints may be composed of a plurality of images captured by an image capturing apparatus having a single image capturing optical system that is moved over time.

The image processing unit 103 applies various kinds of image processing such as A/D conversion, white balance adjustment, gamma correction, and interpolation calculation, to the captured-image signals input from the image capturing unit 102. The image processing unit 103 also performs reconstruction processing (development processing) for generating a reconstructed image, in which a given subject is focused on, from the input signals and the light field information data read out from the memory 104. The image processing unit 103 may be configured as a group of image processing circuits performing each kind of image processing. In the present embodiment, the image processing unit 103 also performs processing for generating, with respect to a reconstructed image that can be generated from the light field information data, an occurrence frequency map (histogram) of the subject's distance corresponding to each pixel. The subject's distance of each subject within the captured range defined by the pixels corresponds to the distance between the subject and the camera system.

The memory 104 is a volatile storage device, or a recording medium such as a memory card or an HDD that records data permanently. The memory 104 serves not only as a loading region for the operation program of each block included in the camera body 100, but also as a temporary storage region for intermediate data that is output during the operation of each block. In the present embodiment, the memory 104 is also used as a storage region for recording a reconstructed image generated by the image processing unit 103 and as a region temporarily storing an image to be displayed by a display unit 105.

The display unit 105 is a display device such as an LCD, which is included in the camera body 100. The display unit 105 displays a reconstructed image generated from the captured-image signals obtained at image capturing, and various kinds of GUI images such as a menu image.

A finder display unit 107 is a display device for image presentation related to an electric viewfinder that the photographer (observer) looks through during an aiming operation. The display region of the finder display unit 107 displays an image based on image signals captured by the image capturing unit 102 during an aiming operation. The reflected light from the image displayed on the display region of the finder display unit 107 reaches an eyeball 18 of the photographer who is looking through the electronic viewfinder via a finder optical system 108.

The electronic viewfinder in the present embodiment also has a detection unit 109 that detects the eye direction of the eyeball 18 looking through the electronic viewfinder. The detection unit 109 includes an infrared LED and an infrared image sensor for example, and detects the eye direction by detecting the corneal reflection light and pupil position of the eyeball 18. The detection unit 109 also specifies, based on the eye direction, which region or position on the image displayed by the finder display unit 107 is closely observed by the eyeball 18. The detection unit 109 outputs information of the region of interest, which is thus specified, to the camera control unit 101.

An operation detection unit 106 is a user interface having operation members such as a release button and a menu button. The operation detection unit 106 detects operational inputs performed on the operation members, and outputs to the camera control unit 101 a control signal corresponding to the operation performed.

Meanwhile, the lens control unit 201 controls the operation of each block included in the lens barrel 200. As described above, the lens control unit 201 is connected with the camera control unit 101 via the electrical contact 11, and the lens control unit 201 controls the operation of each block according to the control signal output by the camera control unit 101 having performed predetermined calculation.

The image capturing optical system 203 is configured to have an objective lens, a focus lens, a shake correction lens, a diaphragm, etc., and an image is formed on the image sensor of the image capturing unit 102 by a light beam reflected from the subject. The focus lens, the shake correction lens, the diaphragm, etc. of the image capturing optical system 203 are configured to be movable within a predetermined range, and they are driven by a drive unit 202. For example, when the camera control unit 101 performs exposure control, a focus evaluation value and an appropriate exposure can be obtained by analyzing a captured image. Therefore, the drive unit 202 controls each optical element of the image capturing optical system 203 according to such information.

Specifically, the camera control unit 101 causes the image processing unit 103 to obtain an appropriate focal position and a diaphragm position based on signals from the image capturing unit 102, transmits the information to the lens control unit 201 via the electrical contact 11, and causes the lens control unit 201 to control the drive unit 202. Furthermore, a camera shake detection sensor, which is not shown in the drawing, is connected to the lens control unit 201. In the mode of performing camera shake correction, the lens control unit 201 transmits to the drive unit 202 a control signal based on a signal from the camera shake detection sensor, and causes the drive unit 202 to drive the shake correction lens in an appropriate manner.

Optical Architecture for Obtaining Images Related to a Plurality of Viewpoints

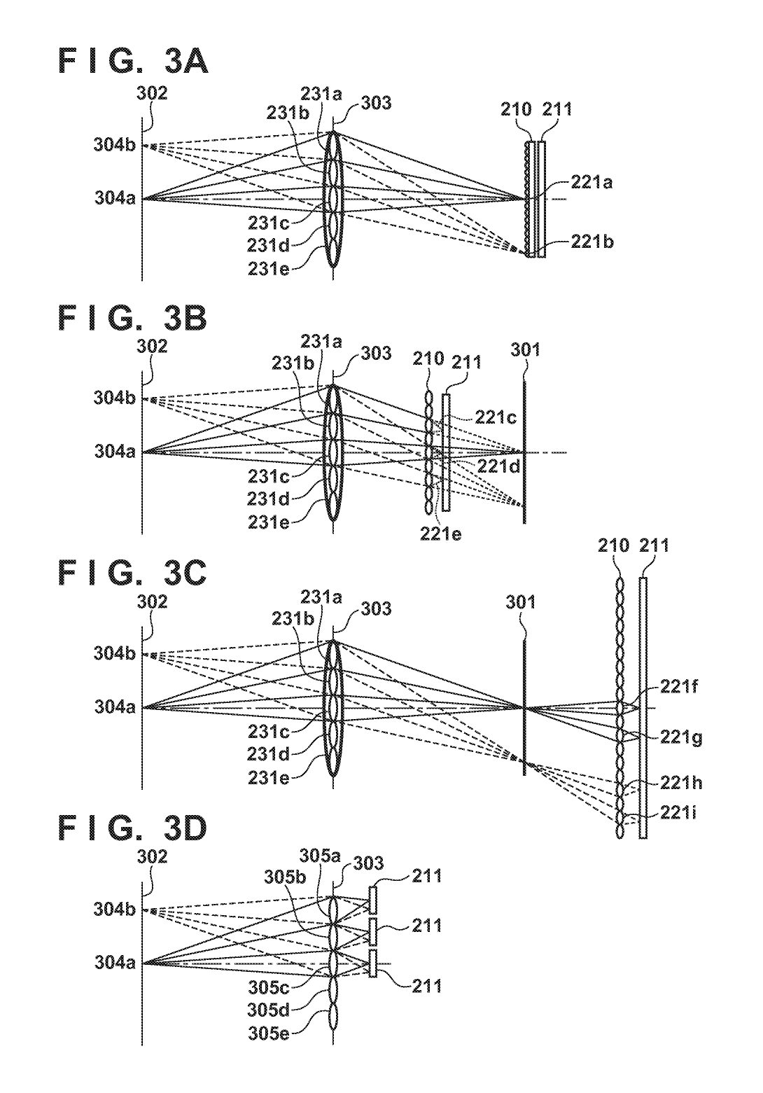

Next, with reference to FIGS. 3A to 3D, a detailed description is given of the fact that the light field information data (data including images related to a plurality of viewpoints) obtained by image capturing performed by the camera system according to the present embodiment can be obtained by using another optical architecture.

FIG. 3A shows an example in which the MLA 210 is disposed near the image forming surface of the image capturing optical system 203, and has the same configuration as the optical system shown in FIG. 2. FIG. 3B and FIG. 3C respectively show an example in which the MLA 210 is disposed closer to the subjects than the image forming surface of the image capturing optical system 203 is, and an example in which the MLA 210 is disposed farther from the subjects than the image forming surface of the image capturing optical system 203 is.

In FIGS. 3A to 3C, the sign 303 indicates a pupil plane of the image capturing optical system 203, the sign 302 indicates an object plane on which a given object exists, and the sign 301 indicates a virtual image forming surface of the main lens of the image capturing optical system 203 (a conjugate plane that is conjugate with the object). In the drawings, the objects (points) respectively located at two positions on the object plane 302 are distinguished from each other by adding a suffix a or b to each, and the reflection light beams related to the point 304a are represented as solid lines, and the reflection light beams related to the point 304b are represented as dashed-dotted lines.

In the example shown in FIG. 3A, the MLA 210 is disposed near the image forming surface of the image capturing optical system 203, and accordingly the image sensor 211 and the pupil plane 303 of the image capturing optical system 203 are in a conjugative relationship. Furthermore, the object plane 302 and the MLA 210 are in a conjugative relationship. Therefore, the light beams from the point 304a on the object plane 302 converge on the microlens 221a, and the light beams from the point 304b converge on the microlens 221b. In other words, each of the light beams, which are emitted from a given point on the object plane 302, pass through the pupil regions 231a to 231e, and reach the virtual image forming surface 301, forms an image on the corresponding photoelectric converter disposed below a microlens that is in a conjugative relationship in terms position with the given point.

In the example shown in FIG. 3B, the image sensor 211 is disposed in the image forming surface on which the light beams from the image capturing optical system 203 are caused to form images by the microlenses 221. This arrangement brings the object plane 302 and the image sensor 211 into a conjugative relationship. In this case, the light beams emitted from the point 304a on the object plane 302 and passing through the pupil region 231a on the pupil plane 303 reach the microlens 221c, and the light beams emitted from the point 304a and passing through the pupil region 231c reach the microlens 221d. Similarly, the light beams emitted from the point 304b on the object plane 302 and passing through the pupil region 231a reach the microlens 221d, and the light beams emitted from the point 304b and passing through the pupil region 231c reach the microlens 221e. As in FIG. 3A, each of the light beams that have passed through a microlens forms an image on the corresponding photoelectric converter disposed below the microlens. In this way, even with respect to light beams emitted from a same point on the object plane 302, each light beam forms an image on a photoelectric converter assigned to a different microlens, depending on the pupil region on the pupil plane 303 that the light beam passes through. Nevertheless, the light field information data obtained in such a manner can be converted to similar data as in the case of the arrangement shown in FIG. 3A, by performing a permutation so that the received light beams are ordered in the arrangement related to the photoelectric converters on the virtual image forming surface 301. In other words, information of the pupil region (i.e. incident angle) that a light beam passed through and the position on the image sensor is available.

In the example shown in FIG. 3C, the image sensor 211 is disposed in the image forming surface on which the light beams from the image capturing optical system 203 are caused by the microlenses 221 to re-form images (light beams that have once formed images and diffused are caused to form images (again)). This arrangement brings the object plane 302 and the image sensor 211 into a conjugative relationship. In this case, the light beams emitted from the point 304a on the object plane 302 and passing through the pupil region 231a on the pupil plane 303 reach the microlens 221g, and the light beams emitted from the point 304a and passing through the pupil region 231c reach the microlens 221f. Similarly, the light beams emitted from the point 304b on the object plane 302 and passing through the pupil region 231a reach the microlens 221i, and the light beams emitted from the point 304b and passing through the pupil region 231c reach the microlens 221h. As in FIG. 3A, each of the light beams that have passed through a microlens forms an image on the corresponding photoelectric converter disposed below the microlens. Nevertheless, the light field information data obtained in such a manner can be converted to similar data as in the case of the arrangement shown in FIG. 3A, by, as in the case of FIG. 3B, performing a permutation so that the received light beams are ordered in the arrangement related to the photoelectric converters on the virtual image forming surface 301. In other words, information of the pupil region (i.e. incident angle) that a light beam passed through and the position on the image sensor is available.

In this way, even with the light field information data obtained by disposing the MLA 210 and the image sensor 211 in a plane that is not in a conjugative relationship with the object plane 302, it is possible to obtain reconstructed data corresponding to the case in which the MLA 210 and the image sensor 211 are disposed near the virtual image forming surface 301 that is the conjugative relationship.

Note that it is possible to obtain data that is equivalent to the light field information data and that includes images related to a plurality of viewpoints without performing the light beam recording involving the pupil division. FIG. 3D shows a configuration for obtaining similar data without using the MLA 210 but using a so-called multi-eye optical system. In the drawing, main lenses 305a to 305e each represent an optical system corresponding to a different viewpoints in a multi-eye optical system, and correspond to the pupil regions 231 shown in FIGS. 3A to 3C. Each main lens 305 causes the light beams passing through it to form images on a different image sensor 211.

In FIGS. 3A to 3C, an example where the data including images related to a plurality of viewpoints is obtained by performing the pupil division by using an MLA (a phase modulator element). However, another optical architecture may be adopted if information of the position and information of the angle (equivalent to limiting the light beam passing area of the pupil) can be obtained with the optical architecture. For example, the light field information data may be obtained by inserting a mask (a gain modulation element) with an appropriate pattern into the light path of the optical imaging system. In addition, another method involving time-division image capturing utilizing camera shake or the motion of the entire image capturing apparatus may be adopted to obtain the data including images related to a plurality of viewpoints.

The data obtained by such an optical architecture includes, in the case of FIGS. 3A to 3C, the images related to the viewpoints corresponding to the positions of the pupil regions 231a to 231e, and in the case of FIG. 3D, the images related to the viewpoints corresponding to the positions of the main lens 305a to 305e. Since the images related to the viewpoints are each located at a different position, they are in the relationship having a parallax between each other, which is similar to the binocular disparity.

Display Control Processing

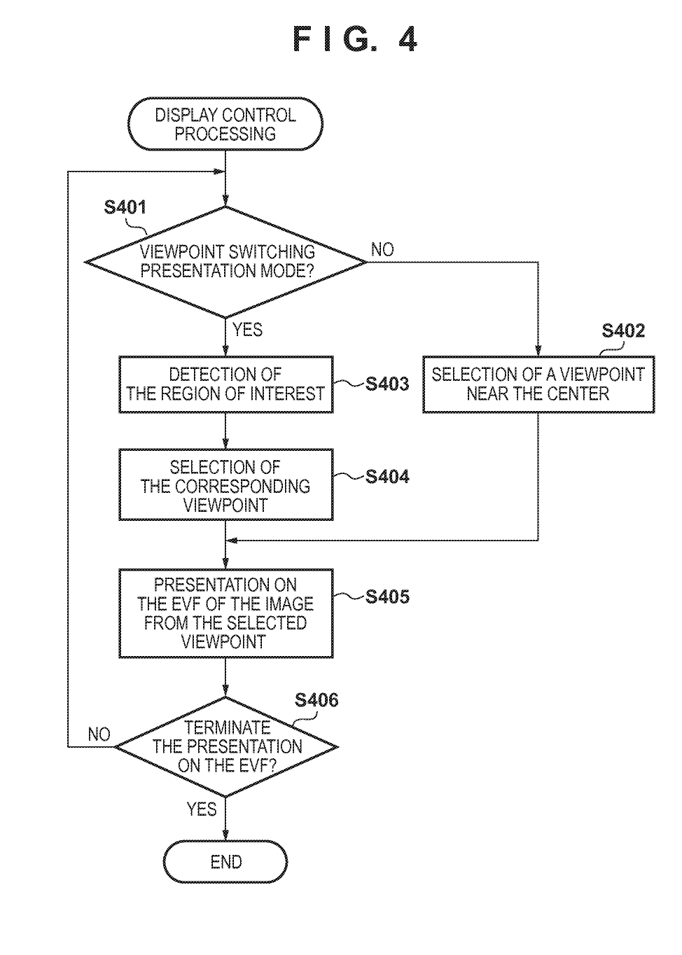

With reference to the flowchart shown in FIG. 4, the following specifically describes the display control processing for the camera system according to the present embodiment having the above-described configuration. The processing corresponding to the flowchart is achieved by the camera control unit 101 reading the corresponding processing program from a non-volatile memory and loading the program to the memory 104 and executing the program, for example. The description of this display control processing is based on the assumption that the processing is started when the photographer's eyeball gets close to the electronic viewfinder when the camera body 100 is in the image capturing mode, for example. For the sake of simplification, it is assumed here that in the display control processing, until an image capturing instruction is made, the image capturing unit 102 performs image capturing at predetermined intervals, and data (light field information data) having images related to a plurality of viewpoints obtained by the image capturing are stored in the memory 104.

At step S401, the camera control unit 101 determines whether or not the image capturing mode that is currently set is the mode for performing image presentation while switching between the viewpoints in the electronic viewfinder. In the present embodiment, the finder display unit 107, when in the image capturing mode, displays, as an image for the electronic viewfinder, one of images related to a plurality of viewpoints obtained by image capturing. In the mode for performing image presentation while switching between the viewpoints, the image to be displayed on the finder display unit 107 is changed according to the change of the region of interest that is closely observed by the eyeball of the photographer as described below. The camera control unit 101, when determining that the image capturing mode that is currently set is the mode for performing image presentation while switching between the viewpoints, the processing moves to step S403, and when determining that the mode is another mode, the processing moves to step S402.

At step S402, the camera control unit 101 selects, as the display viewpoint, the viewpoint related to the pupil region that is in the center of the exit pupil surface from among the plurality of viewpoints related to the images obtained by the image capturing. Note that in the mode for performing image presentation without switching between the viewpoints, the image to be displayed on the finder display unit 107 is not necessarily the image related to the pupil region in the center, and it is only necessary that one of the viewpoints is selected as a fixed viewpoint and the image related to the fixed viewpoint is displayed on the finder display unit 107. Alternatively, instead of an image related to one viewpoint, a reconstructed image in a predetermined focus state, generated from image related to a plurality of viewpoints by a scheme disclosed in Ng, may be displayed on the finder display unit 107.

Meanwhile, in the case of the mode for performing image presentation while switching between the viewpoints, the detection unit 109 detects at step S403 the region of interest of the image displayed on the finder display unit 107, which is the region of interest within the captured range, based on the current eye direction of the photographer. When the processing at this step is performed for the first time, the image related to the pupil region in the center may be displayed on the finder display unit 107 before the region of interest is detected.

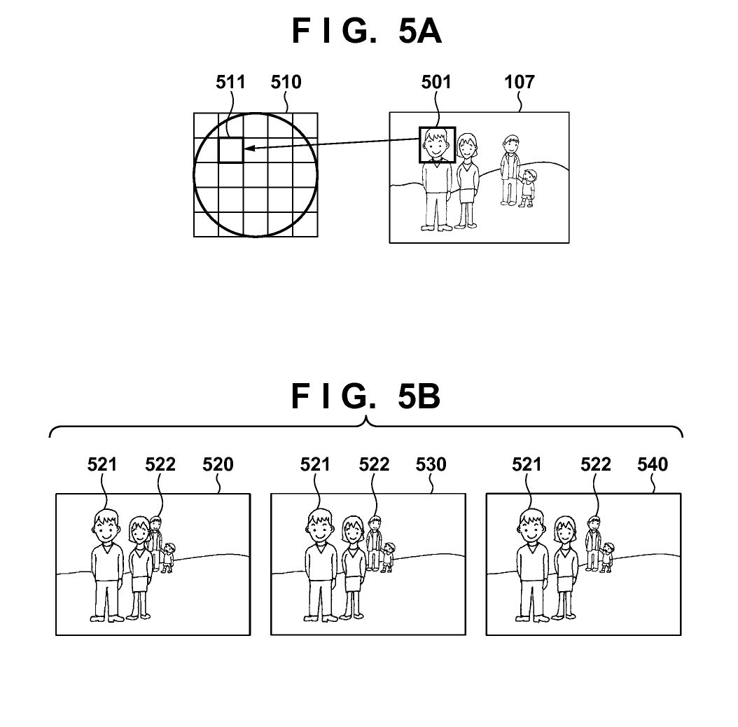

At step S404, the camera control unit 101 selects, as the display viewpoint, the viewpoint corresponding to the detected region of interest, from among the plurality of viewpoints related to the images obtained. The viewpoint corresponding to the region of interest may be, when a plurality of viewpoints are arranged according to the positional relationship thereof, the viewpoint located at the position corresponding to the region of interest within the captured range. In other words, when the images are images obtained by performing the pupil division image capturing as in the present embodiment, the image related to the pupil region corresponding in position on the exit pupil surface to the region of interest within the captured range is selected as the image related to the display viewpoint. Specifically, as shown in FIG. 5A, when the region 501 on the finder display unit 107 is detected as the region of interest, the pupil region 511 corresponding to this region of interest is located at the position shown in the drawing on the exit pupil surface 510. In this way, viewpoint switching, for example displaying a viewpoint from the right side when the photographer looks toward the right side of the screen, can be achieved by selecting the display viewpoint according to the positional relationship between the region of interest within the captured range and the viewpoint. Note that the method for selecting a viewpoint is not limited to the above, and, for example, the viewpoint corresponding to the pupil region that is in the conjugative relationship with the region of interest may be selected. In this case, when the photographer looks toward the right side of the screen, the viewpoint at which the subject is observed from the left side to the right side is displayed. Note that the information of the viewpoint selected according to the region of interest may be determined with reference to a lockup table stored in a non-volatile memory, for example.

At step S405, the camera control unit 101 reads out from the memory 104 the image related to the selected display viewpoint, and transmits the image to the finder display unit 107 to display it.

At step S406, the camera control unit 101 determines whether or not to terminate the image presentation on the finder display unit 107. It is assumed in the camera system according to the present embodiment that the image presentation on the finder display unit 107 is terminated when an image capturing instruction is made or when the photographer's eyeball is moved away from the electronic viewfinder. The camera control unit 101 terminates this display control processing when determining to terminate the image presentation on the finder display unit 107, and when determining not to terminate, the processing returns to step S401.

Accordingly, the image presentation can be performed such that the viewpoint switching is performed according to the region that is closely observed by the photographer, and the photographer is enabled to recognize the three-dimensional shape of the subject even during the aiming.

In the above-described display control processing, it is assumed that the viewpoint corresponding to the region of interest is selected as the display viewpoint. However, since the photographer may quickly move the eye direction, the photographer may be confused if the image to be presented is changed according to the movement. For example, as shown in FIG. 5B, when an image 520 related to a viewpoint A is displayed on the finder display unit 107 and the photographer instantaneously moves the eye direction to the right edge, an image 540 related to a viewpoint C is displayed according to the above-described display control processing. In this case, although a near subject 521 and a distant-view subject 522 overlap each other in the image 520, the near subject 521 and the distant-view subject 522 do not overlap at all in the image 540, and accordingly the photographer might have the impression that the image is switched to a completely different image. For this reason, the display viewpoint may be selected such that, when the amount of movement from the region of interest before being changed to the region of interest after being changed is greater than a predetermined threshold, the image 540 is displayed after an image 530 related to a viewpoint B, which exists between the viewpoints A and C, is displayed. In the image 530, the overlapping area of the near subject 521 and the distant-view subject 522 is smaller than in the image 520, and this gives the photographer the impression that the viewpoint is continuously changed from the image 520 to the image 540. In other words, when the amount of movement of the region of interest is greater than the threshold, control may be performed such that the viewpoints corresponding to the regions existing between the region of interest before the change and the region of interest after the change are selected one after another as the display viewpoint, so that the viewpoint converges to a viewpoint corresponding to the region of interest after the change occurs in the end.

As described above, the information processing apparatus according to the present embodiment, when displaying images related to a plurality of viewpoints, is capable of selecting a display viewpoint that allows for recognition of the three-dimensional shape of the subject in a preferable manner. Specifically, the information processing apparatus obtains information of the plurality of viewpoints corresponding to the images in which a same subject is captured. Then, the apparatus detects the region of interest within the captured range including the subject, selects the viewpoint corresponding to the detected region of interest as the display viewpoint from among the plurality of obtained viewpoints, and displays the image related to the selected viewpoint on a display medium.

Modification 1

The embodiment above gives a description of an example in which the image related to the viewpoint selected in correspondence with the region of interest from among images related to a plurality of viewpoint obtained by image capturing is displayed on the finder display unit 107.

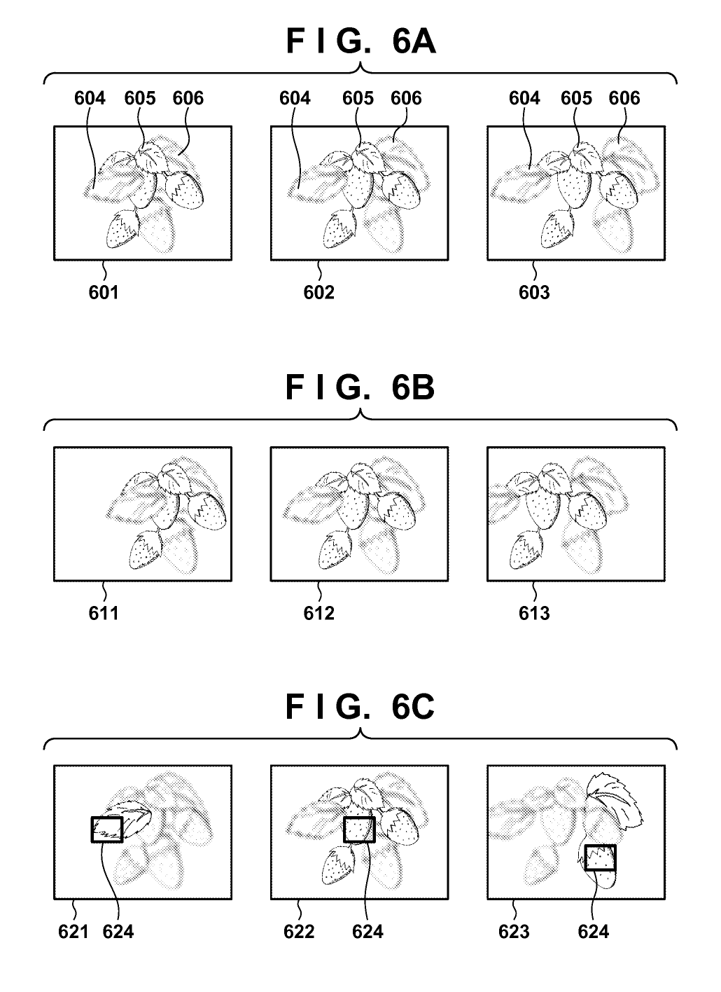

For example, in the case of image capturing performed by an image capturing apparatus having the optical architecture as shown in FIGS. 3A to 3C, when the photographer moves the eye direction toward the right side of the drawing, images 601, 602, and 603 are sequentially displayed on the finder display unit 107 in this order as shown in FIG. 6A. As described above, on the image forming surface, the light beams from the image on the object plane, which is in the conjugative relationship and on which the subject that is in focus exists, converge to a same microlens, and accordingly, the image of a subject 605, which is in focus in FIG. 6A, does not change in position in the image even when the viewpoint is switched to another. In contrast, the image of a near subject 604, which is located closer to the image capturing apparatus than the subject 605 is, is displayed so as to move toward the left side, which is opposite to the eye moving direction, and a distant subject 606, which is located farther than the subject 605 is, is displayed so as to move toward the right side, which is the same as the eye moving direction.

In addition, in the case of image capturing performed by an image capturing apparatus having a multi-eye configuration as shown in FIG. 3D, when the photographer moves the eye direction toward the right side of the drawing, images 611, 612, and 613 are sequentially displayed on the finder display unit 107 in this order as shown in FIG. 6B. In the case of the optical architecture shown in FIG. 3D, if the respective main lenses of the image sensors only differ in viewpoint and face toward parallel directions, the position of the subject's image possibly change in all the images. This is due to the fixed infinity, and the image of any image object at a finite distance moves. Therefore, as shown in FIG. 6B, in the images displayed while being switched therebetween, the all the subjects' images move toward the left side, which is the opposite to the eye moving direction. The amount of the movement is greater for a subject closer to the image capturing apparatus, and smaller for a subject closer to the infinity.

However, when the region of interest is moved according to the movement of the eye direction, if the image related to the corresponding viewpoint is simply displayed, there is the possibility that a subject's image located at the region of interest within the display region in the image before the change moves to another position within the display region in the image after the change. For this reason, the display position of the image after the change may be controlled so that the subject's image in the region of interest within the image that has been displayed before the change will be displayed at the same position within the display region.

In addition, since an eye direction change often occurs when the photographer wishes to closely observe the subject, the image to be displayed on the finder display unit 107 may be generated by applying sharpening processing, by which the image of the subject in the region of interest is sharpened at the highest degree as, the subject in the region of interest is displayed as if the focus is on the subject, as shown in FIG. 6C. In the example shown in FIG. 6C, the region defined by the frame 624 in each of the images 621, 622, and 623 is the region of interest, and the images of the subjects within the region, or the images of the subjects within the same range of depth as the images in the region are sharped.

Modification 2

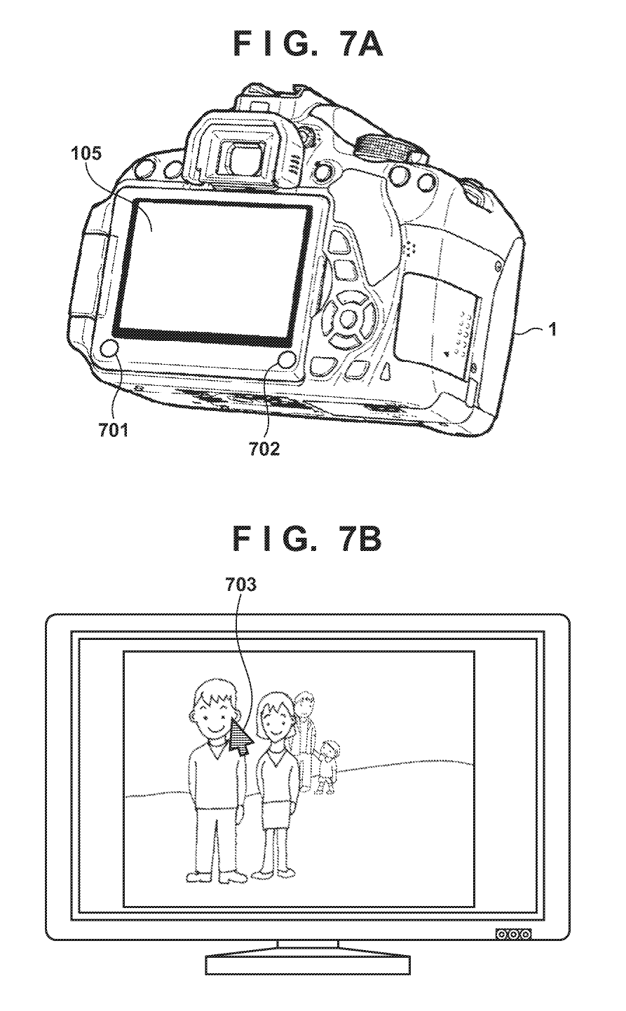

In the above-described embodiment and Modification 1, a description is given of an example in which the present invention is applied to an image to be displayed on the electronic viewfinder. However, the present invention can be applied to any cases if only a unit for detecting the region of interest is provided. For example, the present invention may be applied to the selection of the image to be displayed on the display unit 105 provided in the camera system. In this case, the eye direction and the region of interest may be specified by using outputs from two image capturing units 701 and 702, which are provided at the lower part of the display unit 105 as shown in FIG. 7A for example and serve as a stereo camera. In addition, the present invention may be also applied to the selection of the image to be displayed on a display apparatus such as a liquid crystal monitor by, as shown in FIG. 7B for example, determining the position 703 indicated by a pointing device to be the region of interest.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-121846, filed Jun. 12, 2014, which is hereby incorporated by reference herein in its entirety.

What is claimed is:

1. An information processing apparatus comprising:
an obtaining unit configured to obtain information of a plurality of viewpoints corresponding to images in which a same subject is captured;
a detection unit configured to detect a region of interest within a captured range including the subject;
a selection unit configured to select, as a display viewpoint, a viewpoint corresponding to the region of interest detected by the detection unit from among the plurality of viewpoints obtained by the obtaining unit; and
a display unit configured to display, on a display medium, an image corresponding to the display viewpoint selected by the selection unit, among the images in which the same subject is captured.

2. The information processing apparatus according to claim 1,
wherein, when the plurality of viewpoints are arranged according to a positional relationship thereof, the selection unit selects, as the display viewpoint, a viewpoint located at a position corresponding to a position of the region of interest within the captured range.

3. The information processing apparatus according to claim 2,
wherein the images in which the same subject is captured are images obtained by pupil division image capturing, and
the selection unit selects, as the display viewpoint, a viewpoint corresponding to a pupil region whose position on an exit pupil surface corresponds to a position of the region of interest within the captured range.

4. The information processing apparatus according to claim 1,
wherein the selection unit changes the display viewpoint to another viewpoint when a change is made to the region of interest detected by the detection unit.

5. The information processing apparatus according to claim 4,
wherein, when an amount of movement from the region of interest before the change to the region of interest after the change is greater than a threshold, the selection unit selects, as the display viewpoint, viewpoints corresponding to regions existing between the region of interest before the change and the region of interest after the change, one after another, so that the viewpoint converges to a viewpoint corresponding to the region of interest after the change occurs.

6. The information processing apparatus according to claim 1, further comprising a display unit configured to display an image related to the display viewpoint selected by the selection unit, among the images in which the same subject is captured.

7. The information processing apparatus according to claim 6,
wherein, when a change is made to the region of interest detected by the detection unit, the display unit controls a display position of the image related to the display viewpoint after the change so that an image within the region of interest of the image that has been displayed before the change will be displayed at a same position within a display region.

8. The information processing apparatus of claim 6,
wherein the display unit applies sharpening processing to the image within the region of interest of the image related to the display viewpoint.

9. The information processing apparatus of claim 6,
wherein, while one image from among the images in which the same subject is captured is being displayed by the display unit, the detection unit detects, as the region of interest, a region that is within the one image and that is determined based on an eye direction of an observer.

10. An image capturing apparatus comprising:
an image capturing unit configured to obtain images that are related to a plurality of viewpoints and in which a same subject is captured;
a detection unit configured to detect a region of interest within a captured range including the subject;
a selection unit configured to select, as a display viewpoint, a viewpoint corresponding to the region of interest detected by the detection unit from among the plurality of viewpoints; and
a display unit configured to display, on a display medium, an image corresponding to the display viewpoint selected by the selection unit, among the images related to the plurality of viewpoints.

11. An information processing apparatus control method comprising:
an obtaining step of obtaining information of a plurality of viewpoints corresponding to images in which a same subject is captured;
a detection step of detecting a region of interest within a captured range including the subject;
a selection step of selecting, as a display viewpoint, a viewpoint corresponding to the region of interest detected in the detection step from among the plurality of viewpoints obtained in the obtaining step; and
a display step of displaying, on a display medium, an image corresponding to the display viewpoint selected in the selection step, among the images in which the same subject is captured.
